(19) United States
(12) Patent Application Publication
(10) Pub. No.: US 2026/0228477 A1
(43) Pub. Date: Aug. 6, 2026

(54) IMAGE FORMING APPARATUS, ERROR ALERT METHOD AND STORAGE MEDIUM

(71) Applicant: Kentaro Yoshida, Numazu Shizuoka (JP)

(72) Inventor: Kentaro Yoshida, Numazu Shizuoka (JP)

(73) Assignee: ETRIA Co., Ltd., Kanagawa (JP)

(21) Appl. No.: 19/444,544

(22) Filed: Jan. 9, 2026

(30) Foreign Application Priority Data
Feb. 4, 2025 (JP) 2025-016841

(51) Int. Cl. G06K 15/00; G06K 15/02

(52) U.S. Cl. CPC G06K 15/4055; G06K 15/005; G06K 15/024

(57) ABSTRACT

According to an embodiment, an image forming apparatus includes an image forming unit, an alarm, an external interface, and a processor. The image forming unit forms an image on a medium. The alarm notifies an error. The external interface connects to an external alert device. The processor transitions into a power saving mode in a case where an error occurs in the image forming unit, stops the alarm, and notifies the error by the external alert device connected to the external interface, and the processor stops the notification of the error by the external alert device in a case of returning from the power saving mode, and notifies the error by the alarm.

### CROSS REFERENCE TO RELATED APPLICATIONS

This application is based upon and claims the benefit of priority from Japanese Patent Application No. 2025-016841, filed Feb. 4, 2025, the entire contents of which are incorporated herein by reference.

### FIELD

Embodiments of the present invention relate generally to an image forming apparatus, an error alert method and a storage medium.

### BACKGROUND

Among image forming apparatuses disposed in workplaces, there is an image forming apparatus including a display panel that notifies an operation guidance, the occurrence of an error, and the like. This image forming apparatus displays error information on the display panel in a case where an error has occurred, and waits in a state of being capable of a status response until the error is eliminated. However, in a case where an error has occurred, a conventional image forming apparatus consumes electric power in order to display the error information on the display panel and to keep the state of being capable of a status response. In this image forming apparatus, there is a problem that useless power consumption increases if much time is consumed for eliminating the error.

### BRIEF DESCRIPTION OF THE DRAWING(S)

FIG. 1 is a diagram illustrating an external configuration example of a label printer functioning as an image forming apparatus according to first and second embodiments, and an external alert device.

FIG. 2 is a perspective view illustrating a configuration example in the inside of the label printer functioning as the image forming apparatus according to the first and second embodiments.

FIG. 3 is a side view illustrating a configuration example in the inside of the label printer functioning as the image forming apparatus according to the first and second embodiments.

FIG. 4 is a block diagram illustrating a configuration example of a control system in the label printer functioning as the image forming apparatus according to the first embodiment.

FIG. 5 is a flowchart for describing an operation example at a time of occurrence of an error by the label printer functioning as the image forming apparatus according to the first embodiment.

FIG. 6 is a diagram illustrating a configuration example of the label printer functioning as the image forming apparatus according to the second embodiment, and a network display light.

FIG. 7 is a block diagram illustrating a configuration example of a control system in the label printer functioning as the image forming apparatus according to the second embodiment.

FIG. 8 is a flowchart for describing an operation example at a time of occurrence of an error by the label printer functioning as the image forming apparatus according to the second embodiment.

### DETAILED DESCRIPTION

According to an embodiment, an image forming apparatus includes an image forming unit, an alarm, an external interface, and a processor. The image forming unit forms an image on a medium. The alarm notifies an error. The external interface connects to an external alert device. The processor transitions into a power saving mode in a case where an error occurs in the image forming unit, stops the alarm, and notifies the error by the external alert device connected to the external interface, and the processor stops the notification of the error by the external alert device in a case of returning from the power saving mode, and notifies the error by the alarm.

Hereinafter, a label printer functioning as an image forming apparatus according to each of embodiments is described with reference to the accompanying drawings. The label printer functioning as the image forming apparatus according to each embodiment is placed in a workplace. Note that in the drawings used in the description of each embodiment, the scales of respective parts are, in some cases, varied as appropriate. In addition, for the purpose of easier understanding, in some cases, some structures are omitted in the drawings used in the description of each embodiment.

To begin with, a configuration of a label printer 1 functioning as an image forming apparatus according to first and second embodiments is described.

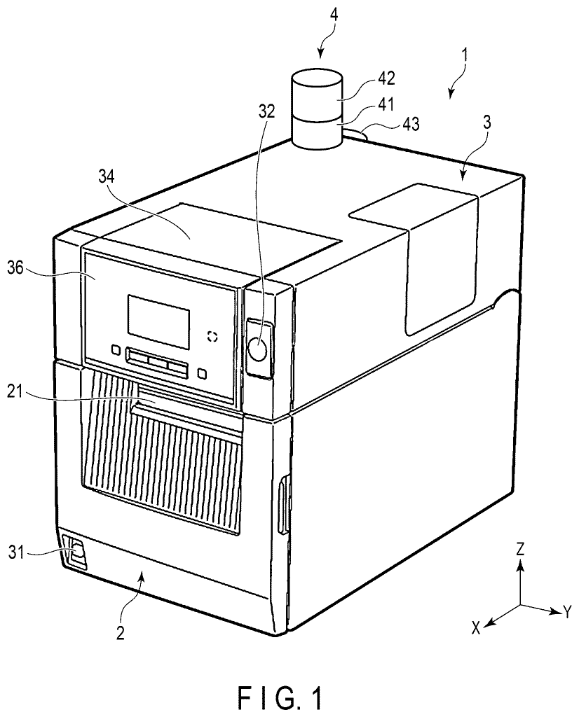

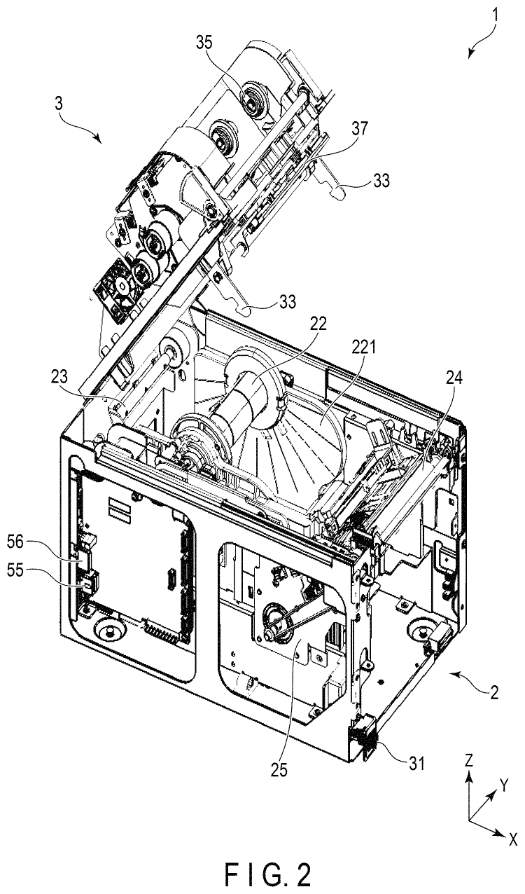

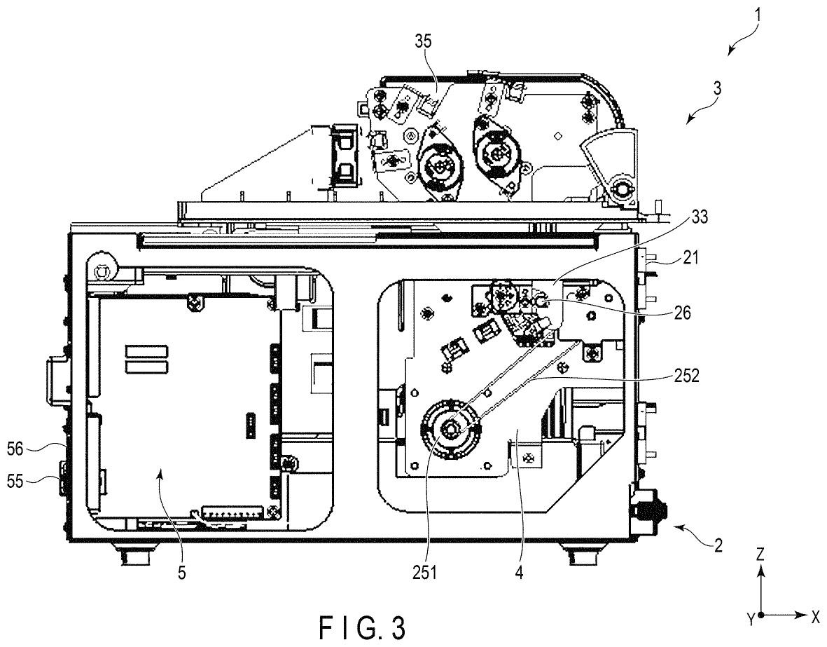

FIG. 1 is a perspective view illustrating an external appearance of the label printer 1 functioning as the image forming apparatus according to the first and second embodiments, and an external alert device 4 connected to the label printer 1 according to the first embodiment. FIG. 2 is a perspective view illustrating a configuration example in the inside of the label printer 1 according to the first and second embodiments. FIG. 3 is a side view illustrating a configuration example in the inside of the label printer 1 according to the first and second embodiments.

As illustrated in FIG. 1, the label printer 1 includes a lower housing 2 and an upper housing 3. The lower housing 2 includes an output port 21, a sheet attachment unit 22, a hinge 23, a platen roller 24, and a motor frame 25. The upper housing 3 includes a power button 31, an open button 32, a hook 33, a ribbon cover 34, a roll attachment unit 35, an operation panel 36, and a thermal head 37.

In FIG. 1, FIG. 2 and FIG. 3, arrows indicating directions with respect to the label printer 1 are described. An arrow X indicates a front-and-rear direction, an arrow Y indicates a right-and-left direction, and an arrow Z indicates an up-and-down direction. For example, in FIG. 1, a direction in which the output port 21 is located is a front direction. A direction opposite to the front direction is a rear direction. For example, in FIG. 1, in regard to a direction crossing the front-and-rear direction, a direction in which the open button 32 is located is a right direction. A direction opposite to the right direction is a left direction. In regard to a direction crossing the front-and-rear direction and the right-and-left direction, a direction in which the upper housing 3 is located is an upward direction. A direction opposite to the upward direction is a downward direction.

The lower housing 2 has a rectangular box shape with an opening in the upward direction. As illustrated in FIG. 2, the lower housing 2 is connected to the upper housing 3 via the hinge 23 provided in the rear direction. The lower housing 2 is an example of a first housing.

As illustrated in FIG. 1, the power button 31 is provided on a wall in the front direction of the lower housing 2. The power button 31 is a button for switching the ON/OFF of power supply to the label printer 1. The output port 21 is provided between the lower housing 2 and the upper housing 3. The output port 21 is a slit for feeding out a label sheet after printing. The label sheet is an example of a printing medium.

The upper housing 3 is connected to the lower housing 2 via the hinge 23 of the lower housing 2. The upper housing 3 is rotatable between an open-state position of FIG. 2 in which the inside of the label printer 1 is opened, and a closed-state position of FIG. 3 in which the inside of the label printer 1 is covered. The upper housing 3 is an example of a second housing.

As illustrated in FIG. 1, the open button 32 is provided in the front direction of the upper housing 3. The open button is a button for operating the hook 33 in order to set the upper housing 3 in the open state.

As illustrated in FIG. 2, the hooks 33 are provided to project downward from the upper housing 3. The hook 33 has a claw-like notched shape. In the closed state of the label printer 1, the hook 33 is engaged with the pin 26 provided at a predetermined position of the lower housing 2, such that a notched portion of the hook 33 is hooked on the pin 26, thereby keeping the closed state of the label printer 1. The hook 33 is operated by the pressing of the open button 32, thereby releasing the engagement state with the pin 26 provided in the lower housing 2. The hook 33 is an example of an engaging portion.

As illustrated in FIG. 1, the ribbon cover 34 is provided in the front direction of the upper housing 3. The ribbon cover 34 is rotatable around an axis in the rear direction of the ribbon cover 34. By setting the ribbon cover 34 in the open state, an ink ribbon can be attached to the roll attachment unit 35 (to be described later) from a gap between the ribbon cover 34 and the cover of the upper housing 3.

As illustrated in FIG. 3, the roll attachment unit 35 is provided in the upper housing 3. The roll attachment unit 35 attaches a feed roll (not illustrated) on which an elongated ink ribbon is wound in a roll shape, and a recovery roll (not illustrated) on which a used ribbon, which has passed through the thermal head 37, is wound up. The feed roll is attached further in the rear direction of the label printer 1 than the recovery roll. The ink ribbon, which is stretched between the feed roll and the recovery roll, is conveyed between the thermal head 37 and the platen roller 24, while being placed over the label sheet.

As illustrated in FIG. 1, the operation panel 36 is provided in the front direction of the ribbon cover 34. The operation panel 36 includes a display unit (display) 361 and an operation unit 362. The display unit 361 displays information relating to the label printer 1. In a case where an error has occurred, the display unit 361 displays information indicating the error. The operation unit 362 accepts various operations relating to the label printer 1.

The sheet attachment unit 22 is a shaft for attaching a label sheet roll in which an elongated label sheet is wound in a roll shape. As illustrated in FIG. 2, both ends of the sheet attachment unit 22 are supported by a holder 221. The holder 221 holds the attached label sheet. The holder 221 can be removed from the lower housing 2 by being pulled up in the upward direction together with the sheet attachment unit 22. The holder 221, which has been removed from the lower housing 2, can be removed from the sheet attachment unit 22. One end of the sheet attachment unit 22 is inserted in a hole of the label sheet roll, and the one end of the sheet attachment unit 22 is fixed by the holder 221, and then the label sheet, together with the holder 221, is attached to the lower housing 2. A spacer may be attached to the sheet attachment unit 22 in accordance with the size in the width direction (right-and-left direction) of the label sheet. The spacer restricts the movement of the label sheet in the right-and-left direction.

The platen roller 24 is provided adjacent to the output port 21 in the front direction of the lower housing 2. The platen roller 24 applies conveying force for pulling the label sheet from the label sheet roll. The platen roller 24 rotates while being in contact with a surface of the label sheet, which is opposite to the printing-side surface of the label sheet. The platen roller 24 is an example of a platen roller.

The thermal head 37 performs printing by applying heat to the label sheet. As illustrated in FIG. 2, the thermal head 37 is provided in the upper housing 3. At a time when the label printer 1 is in the closed state, the thermal head 37 is disposed to be opposed to the platen roller 24 and is pressed on the platen roller 24. Since the platen roller 24 is pressed on the thermal head 37, conveying force can be applied to the label sheet clamped between the platen roller 24 and the thermal head 37 by the rotation of the platen roller 24. The upper housing 3 includes a pressing spring (not illustrated) that presses the thermal head 37 onto the platen roller 24. The thermal head 37 is an example of a thermal head. The thermal head 37 that the label printer 1 of the present embodiment includes can perform printing by a thermal-transfer method or a thermosensitive method.

As illustrated in FIG. 2, the motor frame 25 is provided in such a manner as to sandwich the platen roller 24 in the right-and-left direction. As illustrated in FIG. 3, the motor frame 25 includes a motor 251 and a pulley 252. The motor 251 is connected to the platen roller 24 via the pulley 252, and applies driving force to the platen roller 24. The motor 251, if rotated in a reverse direction, can rotate the platen roller 24 in the reverse direction, and can feed the label sheet backward. The motor frame 25 is an example of a frame.

In addition, a controller (control unit) 5 is provided in the lower housing 2. The control unit 5 is constituted by, for example, a board on which a processor, various kinds of memories and various kinds of interfaces are provided. The processor, various memories and the like in the control unit 5 will be described later. The control unit 5 is provided with a communication interface 55 and a serial interface 56 serving as external interfaces.

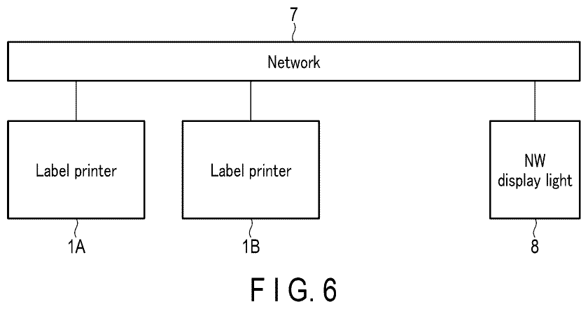

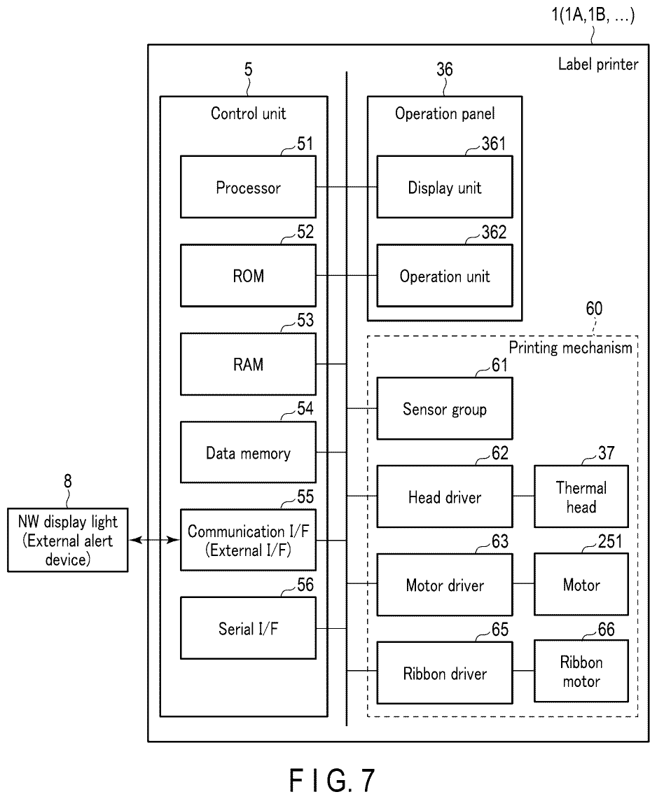

The communication interface 55 is an interface for performing network (NW) communication. The communication interface 55 includes a connector to which a cable for network communication is connected. The connector of the communication interface 55 is provided such that a communication cable can be attached and detached on a rear surface of the lower housing 2 of the printer 1. In a case where the label printer 1 is connected to the network and is operated, the communication interface 55 is connected to the network. For example, in the second embodiment to be described later, the communication network 55 is connected to a network 7 (see FIG. 6) to which an NW display light 8 (see FIG. 6 and FIG. 7) functioning as an external alert device is connected.

The serial interface 56 is an interface for performing serial communication such as a USB (Universal Serial Bus) or the like. The serial interface 56 includes a connector to which a cable for serial communication is connected. The connector of the serial interface 56 is provided such that a communication cable can be attached and detached on the rear surface of the lower housing 2 of the printer 1. In the first embodiment, a cable 43 of the external alert device 4 as illustrated in FIG. 1 is connected to the serial interface 56.

Next, the external alert device 4 connected to the label printer 1 functioning as the image forming apparatus according to the first embodiment is described.

As illustrated in FIG. 1, the external alert device 4 is a device that is connected to the serial interface 56 of the label printer 1. For example, the external alert device 4 is a display light (signal light) that is connected by the USB. In the configuration example illustrated in FIG. 1, the external alert device 4 includes a controller 41, a display unit (display light) 42 and a cable 43 for external connection.

The controller 41 is connected to the display unit 42 and the cable 43. The controller 41 includes a processor, a memory and an interface. For example, the controller 41 is communicably connected to the printer 1 via the cable 43, and controls turn-on and turn-off of the display unit 42 in accordance with a control signal from the printer 1.

The display unit 42 is constituted by a display light or the like, and is turned on or off by the control from the controller 41. The display unit 42 functions as an alert unit (alarm) that notifies the occurrence of an error in the printer 1. The display unit 42 is turned on in order to notify the user of the occurrence of an error in the printer 1. The cable 43 for external connection is a cable that supports a standard corresponding to the serial interface 56 that the label printer 1 includes.

Note that the external alert device 4 may include a component other than the display unit, as the alert unit that notifies the occurrence of an error in the printer 1. For example, the external alert device 4 may include a speaker that produces sound as an alarm notifying the occurrence of an abnormality (error) in the printer 1. In this case, the external alert device 4 may be configured to produce sound as an alarm from the speaker for notifying the occurrence of an error in the printer 1 by the control of the controller 41.

In addition, the controller 41 of the external alert device 4 may be provided with, instead of the external connection cable 43, an external interface including a connector of a cable that supports a specific standard such as the USB. In this case, the controller 41 is connected to the serial interface 56 of the label printer 1 via the cable that is connected to the connector.

Besides, the external alert device 4 may be configured to be connected to the label printer 1 by wireless communication (for example, near-field wireless communication). In this case, it is assumed that the label printer 1 is provided with a wireless communication unit corresponding to a wireless communication function of the external alert device 4. In the case where the external alert device 4 is connected to the label printer 1 by wireless communication, it is assumed that the external alert device 4 includes, instead of the cable 43, a wireless communication unit corresponding to a wireless communication function that the label printer 1 includes.

Next, a description is given of a configuration of a control system in the label printer 1 functioning as the image forming apparatus according to the first embodiment.

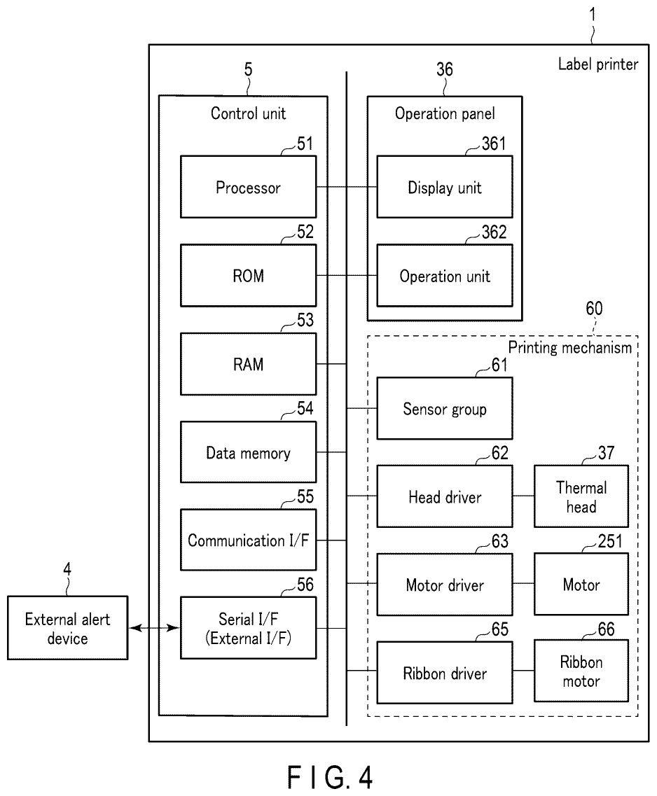

FIG. 4 is a block diagram illustrating a configuration example of the control system in the label printer 1 functioning as the image forming apparatus according to the first embodiment.

In the configuration example illustrated in FIG. 4, the label printer 1 includes the control unit 5, the operation panel 36 and a printing mechanism 60. The control unit 5 includes a processor 51, a ROM (Read Only Memory) 52, a RAM (Random Access Memory) 53, a data memory 54, the communication interface (I/F) 55 and the serial interface (I/F) 56. In the control unit 5, the processor 51, ROM 52, RAM 53, data memory 54, communication interface 55 and serial interface 56 are connected by a bus line including an address bus, a data bus and control signal lines.

The operation panel 36 includes the display unit 361 and the operation unit 362. The display unit 361 and the operation unit 362 are connected to the processor 51 of the control unit 5 via the bus line.

The printing mechanism 60 includes, a sensor group 61, a head driver 62, the thermal head 37, a motor driver 63, the motor 251, a ribbon driver 65, and a ribbon motor 66. The sensor group 61, head driver 62, thermal head 37, motor driver 63, motor 251, ribbon driver 65 and ribbon motor 66 are connected to the processor 51 of the control unit 5 via the bus line.

The processor 51 is a hardware processor that comprehensively controls the label printer 1. The processor 51 controls the respective parts of the label printer 1 and executes various processes, by executing an operating system or a control program. In addition, the processor 51 is connected, via the bus line, to the respective parts in the label printer 1 directly or via a signal input/output circuit, and transmits data signals that are transmitted and received among the parts.

The processor 51 is, for example, a CPU (Central Processing Unit). The processor 51 may include an MPU (Micro Processing Unit), an SoC (System on a Chip), a DSP (Digital Signal Processor), a GPU (Graphics Processing Unit), an ASIC (Application Specific Integrated Circuit), a PLD (Programmable Logic Device), or an FPGA (Field-Programmable Gate Array).

The ROM 52 is a nonvolatile memory. The ROM 52 stores programs that the processor 51 executes, and various kinds of data.

The RAM 53 is a volatile memory. The RAM 53 is a memory that temporarily stores data. For example, the RAM 53 operates as a memory for loading for temporarily storing programs and data in a case where the processor 51 executes the programs.

The data memory 54 corresponds to an auxiliary storage part. The data memory 54 is a rewritable nonvolatile memory. The data memory 54 is constituted by, for example, an HDD (Hard Disk Drive) or an SSD (Solid State Drive).

The data memory 54 stores data that the processor 51 uses in executing various processes, and data created by the processing in the processor 51. In addition, the data memory 54 stores device information indicating a device that is usable as the external alert device 4 (8) that notifies an error in the label printer 1. Specifically, it is assumed that the label printer 1 can use, as the external alert device 4 (or NW display light 8), a device agreeing with the device information of the usable device stored (set) in the data memory 54. The device information of the device usable as the external alert device, however, may be stored in the ROM 52.

The communication interface 55 is an external interface for communication with an external device via a network. The communication interface 55 includes a network interface that supports one or more predetermined communication standards. The communication interface 55 communicates with various devices connected to a network by a protocol stipulated by the communication standard. For example, the communication interface 55 communicates with a host computer, a user terminal, a network device (a network-adaptive external device), and the like, which are connected to the network. In addition, the processor 51 is communicably connected to the host computer (or user terminal) via the communication interface 55, and receives print data for label printing, print commands, and the like, which are supplied from the host computer. Besides, the processor 51 controls the external device by communicating with the external device on the network with the communication protocol such as HTTP or SNMP by the communication interface 55.

The serial interface 56 is an external interface for communicating with an external device that is serially connected. The serial interface 56 is connected to the external alert device 4. The serial interface 56 supplies electric power to the external alert device 4 and outputs to the external alert device 4 a control signal for designating ON/OFF of the display unit 42. For example, the serial interface 56 is constituted by an interface that supports the USB. The processor 51 controls the USB-adaptive external alert device 4 that is connected via the USB interface functioning as the serial interface 56.

The display unit 361 is constituted by a display device that displays information. The display unit 361 functions as an alert unit that notifies an error, which the label printer 1 includes. The display unit 361 is provided at a position where the operator of the label printer 1 can visually recognize a display screen. For example, the display unit 361 displays an operation guidance of the label printer 1, information indicating the state of the label printer 1, and the like. In addition, in a case where an error has occurred, the display unit 361 displays information indicating the content of the error as an error alert. In the display unit 361, power supply thereto is stopped in a power saving mode, and display is turned off.

The operation unit 362 is constituted by an input device for the operator to input an operation instruction. The input device functioning as the operation unit 362 is, for example, various kinds of input buttons, or a touch panel. In addition, the display unit 361 and the operation unit 362 may be constituted by a display device equipped with a touch panel.

The printing mechanism 60 is configured to print an image on a label as a medium, by the thermal head 37 heating an ink ribbon. In the printing mechanism 60, the sensor group 61 including various kinds of sensors is disposed. The sensor group 61 includes, for example, sensors such as a sensor for detecting a conveyed medium, and a sensor for detecting the ink ribbon. The processor 51 controls the respective parts of the printing mechanism 60, based on detection results by the sensors of the sensor group 61.

The head driver 62 is connected to the thermal head 37. The head driver 62 drives the thermal head 37. The thermal head 37 is provided at a predetermined print position. The thermal head 37 includes a plurality of heating elements arranged in a print line in a direction perpendicular to the conveying direction of the medium at the print position. The thermal head 37 is disposed such that the heating elements are put in contact with the ink ribbon that is conveyed while being overlapped with the label at the print position. The thermal head 37 performs printing on the label sheet by the heating elements applying heat to the ink ribbon that is conveyed while being overlapped with the label sheet at the print line.

The head driver 62 heats the heating elements constituting the thermal head 37, based on the print image. For example, the head driver 62 controls the heating state of each heating element in the thermal head 37, in accordance with image data for each print line in the print image of each page to be printed on the medium. The heating elements that are heated at a predetermined print position heat the ink ribbon (or a medium serving as thermosensitive paper) that is pressed on the medium (label material). Thereby, ink corresponding to image data is transferred on the medium on a print line by print line basis.

The motor driver 63 is connected to the motor 251. The motor driver 63 drives the motor 251 in accordance with an instruction from the processor 51. The motor 251 rotates a convey roller, thereby conveying a medium on which an image is printed, along a predetermined convey path. In the present embodiment, it is assumed that the label printer 1 prints an image on the label material as the print medium on which an image is printed. For example, the motor 251 conveys a label sheet in which a plurality of label materials are disposed on elongated, strip-shaped backing paper. The label sheet is a sheet on which a plurality of rectangular label materials are attached on a surface of elongated, strip-shaped backing paper at regular intervals with predetermined gaps (for example, about 1-3 mm). The label sheet is set at a predetermined position in a state in which the label sheet is formed in a roll shape.

The ribbon driver 65 is connected to the ribbon motor 66. The ribbon driver 65 drives the ribbon motor 66 in accordance with an instruction from the processor 51. The ribbon motor 66 conveys the ink ribbon in such a manner that the ink ribbon overlaps the label sheet at the print position. The ribbon motor 66 is a motor that rotates a take-up roller. In addition, the ribbon motor 66 may include a motor that rotates a feed roller and a motor that rotates a take-up roller. The ribbon motor 66 conveys the ink ribbon by rotating the take-up roller, or both the feed roller and the take-up roller.

For example, in the feed roller, an elongated unused ink ribbon is wound in a roll shape. The take-up roller takes up a used ink ribbon, which has passed through the print position, in a roll shape. The ink ribbon is conveyed while being overlapped with the label sheet, through the print position between the feed roller and the take-up roller. The ribbon driver 65 executes such control that the ink ribbon is conveyed by the ribbon motor 66 at the same conveyance speed as the label sheet and in the same direction as the label sheet at the print position.

Next, a description is given of an operation example of an error alert process in a case of occurrence of an error by the label printer 1 functioning as the image forming apparatus according the first embodiment.

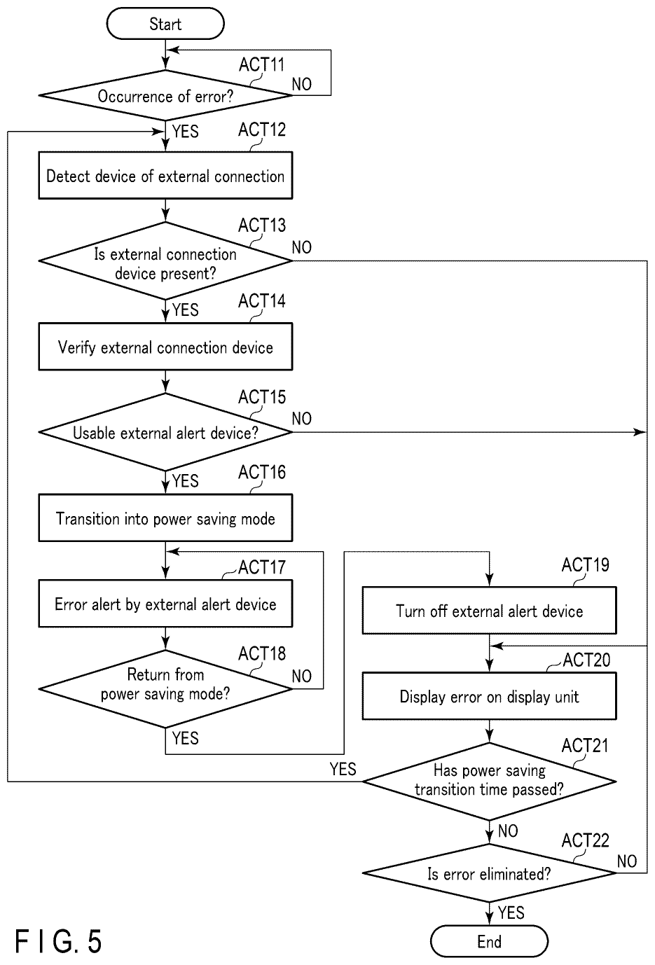

FIG. 5 is a flowchart for describing an operation example at a time of occurrence of an error by the label printer 1 functioning as the image forming apparatus according to the first embodiment.

To start with, the processor 51 of the label printer 1 monitors the occurrence of an error in the print process by the printing mechanism 60 (ACT11). If no error occurs, the processor 51 continues the print process.

If the processor 51 detects the occurrence of an error (ACT11, YES), the processor 51 detects a device (external connection device) that is connected to the serial interface 56 (ACT12). For example, the processor 51 determines whether a device is connected to the serial interface 56. In addition, the processor 51 may store, in the data memory 54 or the like, device information acquired from the device at a time when the device is connected to the serial interface 56.

If the processor 51 detects the external connection device that is connected to the serial interface 56 (ACT13, YES), the processor 51 determines whether the external connection device is a device that can be used as the external alert device of the printer 1 (ACT14).

For example, it is assumed that the printer 1 stores, in the data memory 54 (or ROM 52), the device information of the device that can be used as the external alert device 4 connected to the serial interface 56. The processor 51 acquires the device information from the external connection device connected to the serial interface 56. The processor 51 compares the device information acquired from the external connection device with the device information of the usable external alert device stored in the memory such as the data memory 54. The processor 51 determines whether the external connection device connected to the serial interface 56 is the usable external alert device 4, based on whether the device information of the external connection device agrees with the usable device information.

If the processor 51 determines that the usable external alert device 4 is not connected to the serial interface 56 (ACT15, NO), or if the processor 51 cannot detect the external connection device connected to the serial interface 56 (ACT13, NO), the processor 51 does not transition into the power saving mode and displays the information (error alert) indicating the content of the error on the display unit 361 (ACT20).

In addition, if the processor 51 determines that the usable alert device 4 is connected to the serial interface 56 (ACT15, YES), the processor 51 causes the printer 1 to transition into the power saving mode (ACT16). By the transition into the power saving mode, the processor 51 stops power supply to the display unit 361. Thereby, in the power saving mode, the display by the display unit 361 is turned off.

With the transition into the power saving mode, the processor 51 turns on the display light 42 of the external alert device 4 connected to the serial interface 56 in order to notify the error (ACT17). Also during the power saving mode, the processor 51 supplies power to the external alert device 4 by the serial interface 56. At a time of transitioning into the power saving mode in the state in which the error has occurred, the processor 51 outputs to the external alert device 4 a control signal instructing turn-on of the display light 42.

By the power supplied from the serial interface 56 of the printer 1, the external alert device 4 can operate even while the printer 1 is in the power saving mode. Upon receiving the control signal instructing the turn-on (error alert) of the display light 42 from the printer 1, the controller 41 of the external alert device 4 turns on the display light 42. Specifically, in the case where the error has occurred, the label printer 1 transitions into the power saving mode, and turns on the display light 42 of the external alert device 4 in the power saving mode, without executing the error alert by the display unit. As a result, in the case where the error has occurred, the label printer 1 transitions into the power saving mode, and executes the error alert by the external alert device 4, instead of executing the error alert by the display unit 361.

After turning on the display light 42 of the external alert device 4 in the power saving mode state, the processor 51 of the printer 1 accepts an instruction for returning from the power saving mode (ACT18). For example, if some operational instruction is input to the operation unit 362, the processor 51 assumes that the return from the power saving mode has been instructed. If the instruction for returning from the power saving mode is absent (ACT18, NO), the processor 51 of the printer 1 continues the power saving mode, and continues the turn-on (error alert) of the display light 42 by the external alert device 4.

On the other hand, if the instruction for returning from the power saving mode is received (ACT18, YES), the processor 51 of the printer 1 turns off the display light 42 of the external alert device 4 (turns off the error alert) (ACT19), and returns from the power saving mode. For example, at the time of returning from the power saving mode, the processor 51 outputs the control signal to turn off the display light 42 to the external alert device 42, thereby turning off the error alert by the external alert device 42. Besides, the processor 51 may turn off the display light 42 of the external alert device 4 by stopping the power supply to the external alert device 4 from the serial interface 56.

In addition, in the case of returning from the power saving mode, the processor 51 turns off the display light 42 of the external alert device 4 and displays the error occurring in the printer 1 on the display unit 361 (ACT20). For example, in the case where the error has occurred, the processor 51 stores the information indicating the content of the error in the data memory 54. In the case where the return from the power saving mode was executed, the processor 51 causes the display unit 361 to display the information that is stored in the data memory 54 and that indicates the content of the error that has not been eliminated. In this case, the processor 51 may display on the display unit not only the content of the error but also a guidance of a method of eliminating the error corresponding to the content of the error.

Specifically, at the time of returning from the power saving mode, the label printer 1 turns off the display light 42 of the external alert device 4 and displays the information (error alert) indicating the content of the error on the display unit 361. As a result, at the time of returning from the power saving mode, the label printer 1 can turn off the error alert by the external alert device 4 and can display the information indicating the content of the error on the display unit 361.

In addition, in the state in which the processor 51 returns from the power saving mode and displays the error on the display unit 361, the processor 51 determines whether or not to transition into the power saving mode once again (ACT21). Here, it is assumed that the printer 1 is set to transition into the power saving mode if a no-action state (no-operation state), in which an instruction or the like to the operation unit 362 has not been given, continues for a predetermined time (power saving transition time) or more.

If the continuation time of the no-operation state is within the power saving transition time (ACT21, NO), the processor 51 monitors whether the error displayed on the display unit 361 has been eliminated (ACT22). If the error has been eliminated (ACT22, YES), the processor 51 ends the error alert process and enters a state in which a normal operation can be executed. For example, if the error has been eliminated, the processor 51 may display on the display unit 361 the information indicating that the error has been eliminated or information indicating that printing can be performed.

If the error is not eliminated (ACT22, NO) and the no-operation state continues for the predetermined time (ACT21, YES), the processor 51 determines the transition into the power saving mode. In the case of transitioning into the power saving mode, the processor 51 returns to ACT12, and executes the above-described operation once again. In this case, the processor 51 confirms the connection of the usable external alert device 4 (ACT12-15), transitions into the power saving mode, and notifies the error by using the external alert device 4 while turning off the display unit 361 (ACT16-17). However, in the case where the connection of the usable external alert device 4 has been confirmed, the processor 51 may return to ACT16 and may transition into the power saving mode.

As described above, in the case where an error has occurred, the printer according to the first embodiment transitions into the power saving mode, turns off the display unit, and notifies the error by the external alert device. In addition, at a time of returning from the power saving mode after the occurrence of the error, the printer turns off the error alert by the external alert device and notifies the error by the display unit. Further, in the case where the no-operation state continues after returning from the power saving mode, and the printer transitions into the power saving mode once again, the printer turns off the display unit and notifies the error by the external alert device.

Thereby, in the case where the error has occurred, the printer according to the first embodiment can transition into the power saving mode, can turn off the display unit and can notify the error by the external alert device, and, in the case of returning from the power saving mode, the printer can turn off the external alert device and can display the error alert by the display unit. As a result, the printer according to the first embodiment can notify the error by the external alert device even in the power saving mode, and can reduce useless power consumption without consuming power by both the error alert by the display unit and the error alert by the external alert device.

Moreover, in the printer according to the first embodiment, since the external alert device is connected via the cable, the external alert device can easily be disposed at a position where the external alert device can easily be seen by a user who is present at a distance. As a result, in the power saving mode, the external alert device executes the error alert, and thereby, even if the user is present at a place distant from the printer that is in the power saving mode, the error alert that can easily be recognized by the user can be executed. Moreover, in the state of returning from the power saving mode, the printer according to the first embodiment turns off the external alert device and displays the error content on the display unit. Thereby, the user, who is assumed to be present near the printer that has returned from the power saving mode, can be notified of the information indicating the content of the error, and the external alert device that is useless can be turned off.

Next, the second embodiment is described.

FIG. 6 is a diagram illustrating a configuration example of a printing system including a label printer 1 (1A, 1B) functioning as an image forming apparatus according to the second embodiment.

As illustrated in FIG. 6, the printing system according to the second embodiment is a system in which label printers 1A, 1B are connected to a network (NW) display light 8 functioning as an external alert device via a network 7.

In the label printer 1A, 1B functioning as the image forming apparatus according to the second embodiment, in the configuration illustrated in FIG. 1, the NW display light 8, in place of the external alert device 4, is connected via the network 7. It is assumed that the label printer 1A, 1B functioning as the image forming apparatus according to the second embodiment is implemented by the same configuration as illustrated in FIG. 1 to FIG. 4 described in the first embodiment. Thus, in the description below of the second embodiment, a detailed description of the configuration of the label printer 1A, 1B is omitted.

In the printing system according to the second embodiment, the NW display light 8 is an example of the external alert device that turns on display indicating the state of the label printer 1A, 1B. For example, the NW display light 8 is a network control signal light corresponding to various protocols such as SNMP. The NW display light 8 includes a controller, which includes a network interface, and a display unit (display light). The NW display light 8 controls turn-on and turn-off of the display unit in accordance with a control signal from the label printer 1A, 1B, which is connected via the network 7.

In addition, the NW display light 8 may include a plurality of display units. The NW display light 8 including the display units may be set such that specific display units are associated with the label printers 1A, 1B, which are connected via the network 7. In this case, the NW display light 8 may control turn-on and turn-off of each display unit corresponding to each label printer 1 in accordance with the control signal from each label printer 1A, 1B, which is connected via the network 7.

Next, a description is given of a configuration of a control system in the label printer 1 (1A, 1B) functioning as the image forming apparatus according to the second embodiment.

FIG. 7 is a block diagram illustrating a configuration example of the control system in the label printer 1 (1A, 1B) functioning as the image forming apparatus according to the second embodiment.

As illustrated in FIG. 7, like the configuration illustrated in FIG. 4 described in the first embodiment, the label printer 1 (1A, 1B) includes the control unit 5, operation panel 36 and printing mechanism 60. The structures of the respective parts illustrated in FIG. 7 can be implemented by structures having the same functions as the respective parts illustrated in FIG. 4 described in the first embodiment. Thus, a detailed description of the structures of the respective parts illustrated in FIG. 7 is omitted.

In the label printer 1 (1A, 1B) of the configuration example illustrated in FIG. 7, however, the NW display light 8 functioning as the external alert device is connected to the communication interface 55. The communication interface 55 communicates with the NW display light 8 via the network 7. The communication interface 55 includes a network interface supporting a predetermined communication standard. The communication interface 55 controls the NW display light 8 via the network 7 by the communication protocol of the predetermined communication standard. For example, the processor 51 acquires device information from the NW display light 8 by the communication protocol of the predetermined communication standard by the communication interface 55, and outputs a control signal to the NW display light.

Next, a description is given of an operation example of an error alert process in a case where an error has occurred in the label printer 1 functioning as the image forming apparatus according the second embodiment.

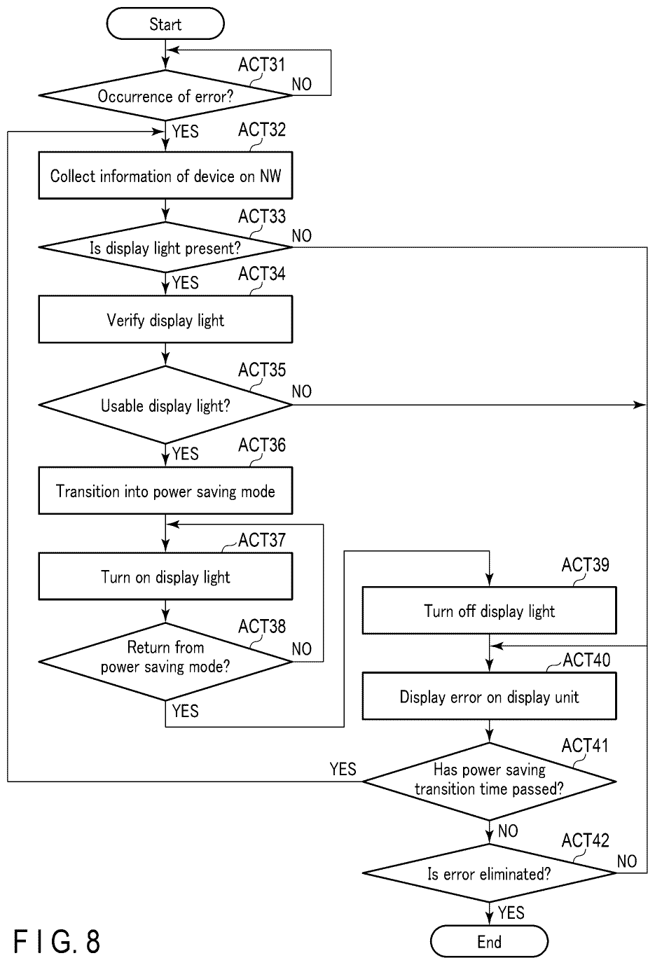

FIG. 8 is a flowchart for describing an operation example at a time of occurrence of an error by the label printer 1 functioning as the image forming apparatus according to the second embodiment.

To start with, the processor 51 of the label printer 1 monitors the occurrence of an error in the print process by the printing mechanism 60 (ACT31). If no error occurs, the processor 51 continues the print process.

If the processor 51 detects the occurrence of an error (ACT31, YES), the processor 51 collects device information of each device (external connection device) connected to the network 7 by the communication interface 55 (ACT32). Based on the device information collected from each device on the network 7 by the communication interface 55, the processor 51 detects a display light connected to the network 7 (ACT33).

For example, the processor 51 collects the device information from each device on the network 7 by SNMP (Simple Network Management Protocol) or HTTP commands. Specifically, the printer 1 stores, in the data memory 54, the IP address of each device included in the printing system. The processor 51 acquires at least a part of the device information from each device by a general-purpose communication protocol such as the SNMP. In addition, the processor 51 may issue a request (HTTP request) that asks for device information from each device connected to the network 7, and may acquire the device information included in a response (HTTP response) from each device.

If the processor 51 detects the display light connected to the network 7 (ACT33, YES), the processor 51 determines whether the display light is a display light that is usable as the external alert device of the printer 1 (ACT34). For example, the printer 1 stores in the memory, such as the data memory 54 or the ROM 52, the device information of the device that is usable as the NW display light 8. The processor 51 verifies whether the device information acquired from the display light on the network 7 agrees with the device information of the NW display light 8 that is usable as the external alert device. Thereby, the processor 51 determines whether the display light on the network 7 is the NW display light 8 that is usable as the external alert device.

If the processor 51 determines that the NW display light 8 that is usable as the external alert device is not connected to the network 7 (ACT35, NO), or if the display light connected to the network 7 cannot be detected (ACT33, NO), the processor 51 displays the information indicating the content of the error on the display unit 361, without transitioning into the power saving mode (ACT40).

If the processor 51 determines that the NW display light 8 that is usable as the external alert device is connected to the network 7 (ACT35, YES), the processor 51 causes the printer 1 to transition into the power saving mode (ACT36). In this case, by transitioning into the power saving mode, the processor 51 stops the power supply to the display unit 361 and turns off the display by the display unit 361.

In addition, with the transition into the power saving mode, the processor 51 turns on the NW display light 8 of the network 7, which is used as the external alert device (ACT37). For example, at the time of transitioning into the power saving mode in the state in which the error has occurred, the processor 51 outputs to the NW display light 8 the control signal to instruct the turn-on of the display unit. The NW display light 8 is turned on in response to the control signal instructing the turn-on (error alert) from the printer 1.

Specifically, in the case where the error has occurred, the printer 1 transitions into the power saving mode, turns off the display unit, and turns on the NW display light 8 in the power saving mode state. Thereby, in the case where the error has occurred, the printer can transition into the power saving mode, and can turn on the NW display light 8 without executing the error alert by the display unit.

In addition, upon turning on the NW display light 8 in the power saving mode state, the processor 51 of the printer 1 accepts an instruction for returning from the power saving mode (ACT38). If the instruction for returning from the power saving mode is absent (ACT38, NO), the processor 51 continues the power saving mode, and continues the turn-on (error alert) of the NW display light 8.

On the other hand, if the instruction for returning from the power saving mode is received (ACT38, YES), the processor 51 of the printer 1 turns off the NW display light 8 (turns off the error alert) (ACT39), and returns from the power saving mode. For example, at the time of returning from the power saving mode, the processor 51 outputs the control signal to turn off the NW display light 8, thereby turning off the error alert by the NW display light 8.

In the case of returning from the power saving mode, the processor 51 turns off the NW display light 8 and displays on the display unit 361 the error that has occurred in the printer 1 (ACT40). For example, if the error has occurred, the processor 51 stores the information indicating the content of the error in the data memory 54 until the error is eliminated. If the processor 51 returns from the power saving mode, the processor 51 displays on the display unit 361 the information that is stored in the data memory 54 and that indicates the content of the error that has not been eliminated. Besides, the processor 51 may display on the display unit not only the content of the error but also a guidance of a method of eliminating the error corresponding to the content of the error.

Specifically, at the time of returning from the power saving mode, the printer 1 turns off the NW display light 8 and displays the information indicating the content of the error on the display unit 361. Thereby, at the time of returning from the power saving mode, the printer 1 can turn off the NW display light 8 and can display the information indicating the content of the error on the display unit 361.

In addition, in the state in which the processor 51 returns from the power saving mode and displays the error on the display unit 361, the processor 51 determines whether or not to transition into the power saving mode (ACT41). Here, it is assumed that the printer 1 is set to transition into the power saving mode if a no-operation state, in which an instruction or the like to the operation unit 362 has not been given, continues for a predetermined time (power saving transition time) or more. The processor 51 measures the continuation time of the no-operation state, and determines whether the continuation time of the no-operation state has reached the power saving transition time.

If the continuation time of the no-operation state is within the power saving transition time (ACT41, NO), the processor 51 continues the error display by the display unit 361 and monitors whether the error displayed on the display unit 361 has been eliminated (ACT42). If the processor 51 detects that the error has been eliminated (ACT42, YES), the processor 51 ends the error alert process and enters a state in which a normal operation can be executed. For example, if the error has been eliminated, the processor 51 displays on the display unit 361 information indicating that the error has been eliminated or information indicating that printing can be performed, and accepts a normal operation instruction.

If the error is not eliminated (ACT42, NO) and the no-operation state continues for the predetermined time (ACT41, YES), the processor 51 determines the transition into the power saving mode. In the case of transitioning into the power saving mode, the processor 51 returns to ACT32, and executes the above-described operation once again. In this case, the processor 51 confirms the connection of the usable NW display light 8 to the network, transitions into the power saving mode, and turns on the NW display light 8 (ACT32-37). However, in the case where the connection of the usable NW display light 8 has been confirmed, the processor 51 may return to ACT36 and may transition into the power saving mode.

As described above, in the case where an error has occurred, the printer functioning as the image forming apparatus according to the second embodiment transitions into the power saving mode, turns off the display unit, and turns on the NW display light. In addition, at a time of returning from the power saving mode after the occurrence of the error, the printer turns off the NW display light and notifies the error by the display unit. Further, in the case where the no-operation state continues after returning from the power saving mode, and the printer transitions into the power saving mode once again, the printer turns off the display unit and turns on the NW display light.

Thereby, according to the second embodiment, in the case where the error has occurred, the printer can transition into the power saving mode, can turn off the display of the display unit, and can turn on the NW display light. Furthermore, at the time of returning from the power saving mode, the printer can turn off the NW display light, and can display the information indicating the content of the error on the display unit. As a result, the printer can execute the error alert that can easily be recognized by the user, while reducing useless power consumption.

Besides, in the case where the user is at a distance from the printer, the printer transitions into the power saving mode after the continuation of the no-operation state for a predetermined time, and turns on the NW display light, thereby notifying the error. Since the NW display light is connected to the network, the NW display light can easily be disposed such that the NW display light can easily be visually recognized from a place at a distance from the printer. The printer turns on the NW display light in the power saving mode, thereby enabling the user, who is at a distance from the printer, to easily recognize the error. Moreover, in the case where the user is present near the printer, the printer returns from the power saving mode by an operation instruction or the like, turns off the external alert device, and notifies the error by the display unit. Thereby, the printer can execute the error alert that is easily recognizable in accordance with the situation of the user, while reducing useless power consumption.

Note that in the first and second embodiments, the ROM 52 or the data memory 54 of the printer 1 is a nonvolatile storage medium that stores a program for the processor 51 to execute above-described process or control. An individually transferred program may be written in the data memory 54 that is the writable storage device included in the label printer 1, in accordance with an operation of an administrator or the like. In addition, The program may be transferred by being stored in a removable, non-transitory tangible computer-readable storage medium, or may be transferred by communication via a network. The non-transitory tangible computer-readable storage medium may be any medium that can store program data, such as an optical disc or a memory card, and that can be read by a device.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to form an image on a medium;
an alarm configured to notify an error;
an external interface configured to be connected to an external alert device; and
a processor configured to transition into a power saving mode in a case where an error occurs in the image forming unit, to stop the alarm, and to notify the error by the external alert device connected to the external interface, and configured to stop the notification of the error by the external alert device in a case of returning from the power saving mode, and to notify the error by the alarm.

2. The image forming apparatus of claim 1, wherein the processor is configured to stop the alarm and to notify the error by the external alert device, in a case where the error is not eliminated after returning from the power saving mode and a transition occurs once again into the power saving mode.

3. The image forming apparatus of claim 1, wherein
the alarm is a display configured to display information, and
the processor is configured to display information indicating content of the error on the display in the case of returning from the power saving mode.

4. The image forming apparatus of claim 1, wherein
the external alert device includes a display light, and
the processor is configured to turn on the display light in order to notify the error in the power saving mode, and to turn off the display light in the case of returning from the power saving mode.

5. The image forming apparatus of claim 1, wherein the external interface is a serial interface for serial connection to the external alert device.

6. The image forming apparatus of claim 5, wherein
the external alert device is a device configured to be connected to a USB interface, and
the serial interface is the USB interface.

7. The image forming apparatus of claim 5, further comprising a memory configured to store device information indicating a device that is usable as the external alert device, wherein
in a case where device information acquired from a device connected to the serial interface agrees with the device information stored in the memory, the processor is configured to set the device connected to the serial interface to be the external alert device.

8. The image forming apparatus of claim 1, wherein the external interface is a network interface for communicable connection to a network to which the external alert device is connected.

9. The image forming apparatus of claim 8, further comprising a memory configured to store device information indicating a device that is usable as the external alert device, wherein
the processor is configured to acquire device information from a device connected to a network that is communicable by the network interface, and, in a case where a device that agrees with the device information stored in the memory is connected to the network that is communicable by the network interface, the processor is configured to set the device that agrees with the device information to be the external alert device.

10. The image forming apparatus of claim 9, wherein
the external alert device is a device including a communication interface that supports a predetermined network communication standard,
the network interface is an interface corresponding to the predetermined network communication standard, and the processor is configured to acquire device information from a device connected to the network, based on the predetermined network communication standard.

11. An error alert method in an image forming apparatus including an image forming unit configured to form an image on a medium, an alarm, and an external interface configured to be connected to an external alert device, the method comprising:
transitioning into a power saving mode in a case where an error occurs in the image forming unit, stopping the alarm, and notifying the error by the external alert device connected to the external interface; and
stopping the notifying of the error by the external alert device in a case of returning from the power saving mode, and notifying the error by the alarm.

12. The error alert method of claim 11, further comprising stopping the alarm and notifying the error by the external alert device, in a case where the error is not eliminated after returning from the power saving mode and a transition occurs once again into the power saving mode.

13. The error alert method of claim 11, further comprising displaying information indicating content of the error on a display functioning as the alarm in the case of returning from the power saving mode.

14. The error alert method of claim 11, further comprising turning on a display light that the external alert device includes, in order to notify the error in the power saving mode, and turning off the display light in the case of returning from the power saving mode.

15. The error alert method of claim 11, further comprising:
storing, in a memory, device information indicating a device that is usable as the external alert device; and
setting, in a case where device information acquired from a device that communicates by the external interface agrees with the device information stored in the memory, the device that communicates by the external interface to be the external alert device.

16. A non-transitory storage medium storing a program, the program causing a processor of an image forming apparatus including an image forming unit configured to form an image on a medium, an alarm, and an external interface configured to be connected to an external alert device, to execute:
transitioning into a power saving mode in a case where an error occurs in the image forming unit, stopping the alarm, and notifying the error by the external alert device connected to the external interface; and
stopping the notifying of the error by the external alert device in a case of returning from the power saving mode, and notifying the error by the alarm.

17. The storage medium of claim 16, wherein the program causes the processor to execute stopping the alarm and notifying the error by the external alert device, in a case where the error is not eliminated after returning from the power saving mode and a transition occurs once again into the power saving mode.

18. The storage medium of claim 16, wherein the program causes the processor to execute displaying information indicating content of the error on a display functioning as the alarm in the case of returning from the power saving mode.

19. The storage medium of claim 16, wherein the program causes the processor to execute turning on a display light that the external alert device includes, in order to notify the error in the power saving mode, and turning off the display light in the case of returning from the power saving mode.

20. The storage medium of claim 16, wherein the program causes the processor to execute:
accessing a memory configured to store device information indicating a device that is usable as the external alert device; and
setting, in a case where device information acquired from a device that communicates by the external interface agrees with the device information stored in the memory, the device that communicates by the external interface to be the external alert device.
